(19) United States
(12) Patent Application Publication
(10) Pub. No.: US 2026/0303748 A1
(43) Pub. Date: Oct. 1, 2026

(54) NON-TRANSITORY COMPUTER-READABLE STORAGE MEDIUM STORING FAX CONTROL PROGRAM, FAX CONTROL DEVICE, AND A CONTROL METHOD

(71) Applicant: SEIKO EPSON CORPORATION, TOKYO (JP)

(72) Inventor: Masayuki MOMOI, SHIOJIRI-SHI (JP)

(21) Appl. No.: 19/629,108

(22) Filed: Mar. 26, 2026

(30) Foreign Application Priority Data
Mar. 26, 2025 (JP) 2025-051951

(51) Int. Cl. H04N 1/32

(52) U.S. Cl. CPC H04N 1/32566; H04N 1/32363; H04N 1/32587

(57) ABSTRACT

A FAX transmission job acquisition unit acquires a first FAX transmission job generated by a general-purpose printer driver. A job transmission destination reception unit receives a plurality of job transmission destinations as job transmission destinations of the first FAX transmission job. A FAX transmission job generation unit generates at least one second FAX transmission job including image data of the first FAX transmission job. A job transmission destination setting unit sets respective job transmission destinations of a plurality of FAX transmission jobs including the first FAX transmission job and the at least one second FAX transmission job as the plurality of job transmission destinations received by the job transmission destination reception unit. A job transmission unit transmits the plurality of FAX transmission job to a multifunction peripheral.

The present application is based on, and claims priority from JP Application Serial Number 2025-051951, filed Mar. 26, 2025, the disclosure of which is hereby incorporated by reference herein in its entirety.

### BACKGROUND

### 1. Technical Field

The present disclosure relates to a non-transitory computer-readable storage medium storing a FAX control program, a FAX control device, and a control method.

### 2. Related Art

JP-A-2023-140588 discloses a multifunction peripheral having a PC-FAX function.

In a general-purpose printer driver such as an OS-standard printer driver, a PC-FAX function itself can be used, but a plurality of transmission destinations cannot be set as transmission destinations for fax transmission, and thus there is room for improvement.

### SUMMARY

A non-transitory computer-readable storage medium storing a FAX control program according to an aspect of the present disclosure is provided. The FAX control program is a program for causing a computer to function as an extension application that extends a general-purpose printer driver. The extension application includes a FAX transmission job acquisition unit configured to acquire a first FAX transmission job generated by the general-purpose printer driver, a job transmission destination reception unit configured to receive a plurality of job transmission destinations as job transmission destinations of the first FAX transmission job, a FAX transmission job generation unit configured to generate at least one second FAX transmission job including image data of the first FAX transmission job, a job transmission destination setting unit configured to set respective job transmission destinations of a plurality of FAX transmission jobs including the first FAX transmission job and the at least one second FAX transmission job to the plurality of job transmission destinations received by the job transmission destination reception unit, and a job transmission unit configured to transmit the plurality of FAX transmission jobs to an external device.

A FAX control device according to an aspect of the present disclosure is provided. The FAX control device includes a general-purpose printer driver, and an extension application that extends the general-purpose printer driver. The extension application includes a FAX transmission job acquisition unit configured to acquire a first FAX transmission job generated by the general-purpose printer driver, a job transmission destination reception unit configured to receive a plurality of job transmission destinations as job transmission destinations of the first FAX transmission job, a FAX transmission job generation unit configured to generate at least one second FAX transmission job including image data of the first FAX transmission job, a job transmission destination setting unit configured to set respective job transmission destinations of a plurality of FAX transmission jobs including the first FAX transmission job and the at least one second FAX transmission job to the plurality of job transmission destinations received by the job transmission destination reception unit, and a job transmission unit configured to transmit the plurality of FAX transmission jobs to an external device.

A control method for a FAX control device according to an aspect of the present disclosure is provided. The FAX control device includes a general-purpose printer driver and an extension application that extends the general-purpose printer driver. The control method includes acquiring, by the extension application, a first FAX transmission job generated by the general-purpose printer driver; receiving, by the extension application, a plurality of job transmission destinations as job transmission destinations of the first FAX transmission job; generating, by the extension application, at least one second FAX transmission job including image data of the first FAX transmission job; setting, by the extension application, respective job transmission destinations of a plurality of FAX transmission jobs including the first FAX transmission job and the at least one second FAX transmission job to the plurality of job transmission destinations received; and transmitting, by the extension application, the plurality of FAX transmission jobs to an external device.

### BRIEF DESCRIPTION OF THE DRAWINGS

FIG. 1 is a block diagram of a FAX system.

FIG. 2 is a functional block diagram of a computer.

FIG. 3 is a diagram illustrating a print dialog.

FIG. 4 is a data structure diagram of a FAX transmission job.

FIG. 5 is a diagram illustrating a transmission destination setting dialog.

FIGS. 6A to 6D are data structure diagrams of a plurality of FAX transmission jobs.

FIGS. 7A to 7D are data structure diagrams of a plurality of FAX transmission jobs.

FIGS. 8A to 8D are data structure diagrams of a plurality of FAX transmission jobs.

FIG. 9 is a control flow of a PSA.

FIG. 10 is a control flow of the PSA.

FIG. 11 is a management window of a print spooler.

### DESCRIPTION OF EMBODIMENTS

Although an embodiment of the present disclosure will be described below, the scope of the disclosure as defined by the claims is not limited to the following embodiment. In addition, not all of the configurations described in the embodiment are essential for solving the problem. For clarity of description, the following description and drawings are omitted or simplified as appropriate. In each drawing, the same components are denoted by the same reference numerals, and repeated descriptions are omitted as necessary.

In the following embodiment, the description will be divided into multiple sections or embodiments as needed for convenience. However, unless otherwise stated, these are not mutually independent but are related in that one may be a modified example, applied example, detailed description, or supplementary explanation, in whole or in part, of another. Additionally, when a number or the like (including a number, a value, an amount, a range, and the like) of elements is mentioned in the following embodiment, the number or the like is not limited to a specific number, for example, unless explicitly stated otherwise or unless obviously limited to the specific number in theory. The number or the like may be equal to, greater than, or less than the specific number.

Additionally, in the following embodiment, components (including operation steps and the like) are not necessarily essential, for example, unless otherwise stated or unless obviously considered to be essential in theory. Similarly, when the shape, positional relationship, or the like of a component or the like is mentioned in the following embodiment, for example, shapes or the like that are substantially approximate or similar to that shape or the like are also encompassed, for example, unless otherwise stated or unless obviously considered otherwise in theory. The same applies to the number or the like (including the number, numerical value, amount, and range) described above.

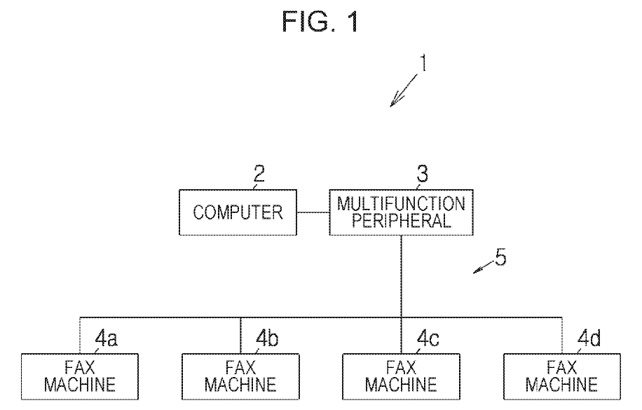

FIG. 1 illustrates a block diagram of a FAX system 1. The FAX system 1 includes a computer 2 and a multifunction peripheral 3. The computer 2 and the multifunction peripheral 3 are configured to be capable of bidirectional communication via a network such as a local area network (LAN) or a wide area network (WAN) according to the Internet Printing Protocol (IPP). The computer 2 is a specific example of a FAX control device. The multifunction peripheral 3 is a specific example of an external device and is compatible with a PC-FAX function. Therefore, the computer 2 can transmit document data as it is via the multifunction peripheral 3 using a FAX without printing the document data. FIG. 1 illustrates, as transmission destinations of FAX transmission, a FAX machine 4a, a FAX machine 4b, a FAX machine 4c, and a FAX machine 4d. The FAX machine 4a, the FAX machine 4b, the FAX machine 4c, and the FAX machine 4d are configured to be capable of bidirectional communication with the multifunction peripheral 3 via a public switched telephone network (PSTN) 5.

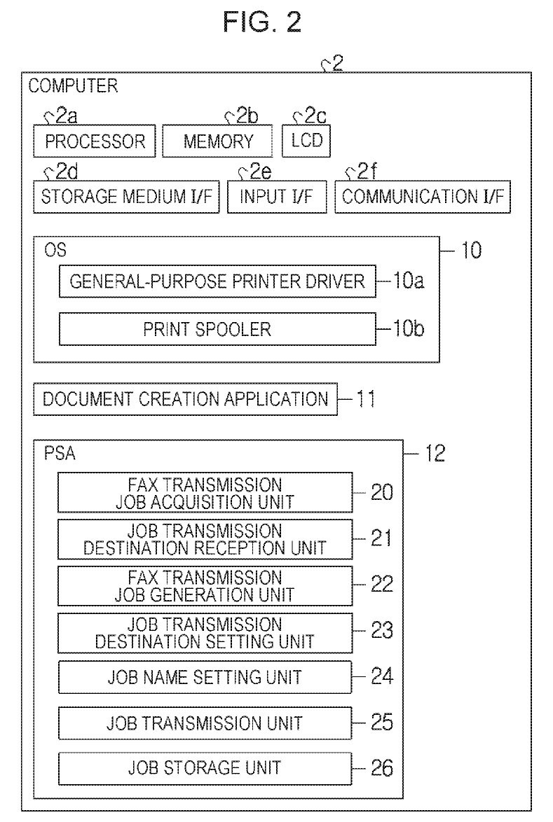

FIG. 2 illustrates a functional block diagram of the computer 2. The computer 2 is implemented by a single device. However, the disclosure is not limited thereto, and the computer 2 may be implemented by distributed processing performed by a plurality of devices.

In the present embodiment, the computer 2 is implemented by a computer such as a personal computer or a workstation. The computer 2 includes a processor 2a, a memory 2b, a liquid crystal display (LCD) 2c, a storage medium interface 2d, an input interface 2e, and a communication interface 2f.

The processor 2a is typically any one of a central processing unit (CPU), a graphics processing unit (GPU), a field programmable gate array (FPGA), and an application-specific integrated circuit (ASIC).

The memory 2b includes a main storage device and an auxiliary storage device. The main storage device is typically a random access memory (RAM) or a read only memory (ROM). The auxiliary storage device is typically a hard disk drive (HDD) or a solid state drive (SSD).

The memory 2b stores programs that cause the computer 2 to function as an operating system (OS) 10, a document creation application 11, and a print support application (PSA) 12. The processor 2a reads the programs from the memory 2b and executes the programs. Thus, the processor 2a causes hardware such as the processor 2a and the memory 2b to function as the OS 10, the document creation application 11, and the PSA 12. The program, which causes the computer 2 to function as the PSA 12, corresponds to a FAX control program. The memory 2b also stores temporary work data required to execute the OS 10, the document creation application 11, and the PSA 12.

The LCD 2c is a specific example of an output device. The LCD 2c may be built in the computer 2 or may be an external device of the computer 2.

The storage medium interface 2d is an interface for the processor 2a to access an external storage medium. The external storage medium is typically an SD card, a USB memory, an external HDD, an external SSD, an optical disk, a network attached storage (NAS), or a magnetic tape.

The input interface 2e is an interface for a user to input a command to the computer 2. The input interface 2e is typically a keyboard, a mouse, a touch pad, or a touch panel.

The communication interface 2f is an interface for the processor 2a to communicate with the multifunction peripheral 3 via a network. The communication interface 2f is typically an Ethernet module (registered trademark), a Wi-Fi module (registered trademark), or a Bluetooth module (registered trademark).

The document creation application 11 is a specific example of a user application. The user application is not limited to the document creation application 11, and may be an image creation application, a presentation material creation application, or a spreadsheet application.

The OS 10 is basic software for controlling operations of the computer 2. The OS 10 may be, for example, Windows (registered trademark), but is not limited thereto. In the following description, an example will be described in which the OS 10 is Windows.

The OS 10 includes a general-purpose printer driver 10a and a print spooler 10b. The general-purpose printer driver 10a is a printer driver that provides standard printing functions provided by Windows. The general-purpose printer driver 10a is called by a user application such as the document creation application 11 to execute various processes. The general-purpose printer driver 10a is installed on the computer 2 together with the OS 10. It can also be said that the general-purpose printer driver 10a is a printing function accompanying the OS 10. The general-purpose printer driver 10a is also referred to as an IPP Class Driver. The print spooler 10b temporarily stores a job sent from a user application such as the document creation application 11 and sequentially delivers the job to the PSA 12.

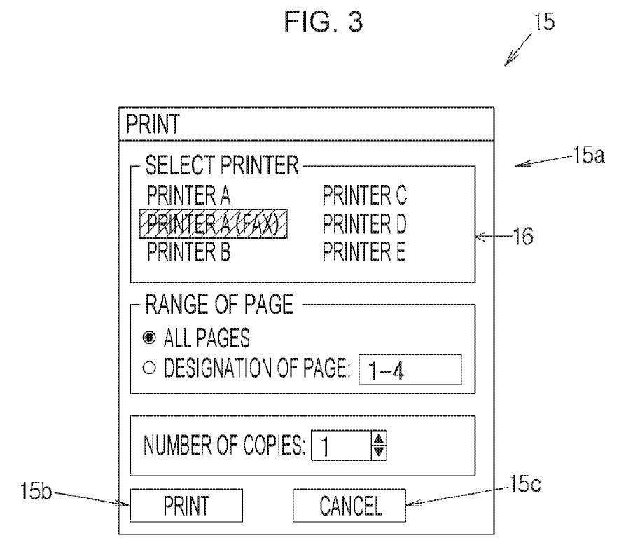

When the document creation application 11 calls the general-purpose printer driver 10a, the document creation application 11 converts document data created by a user using the document creation application 11 into image data in an XML Paper Specification (XPS) format or a graphics device interface (GDI) format, and delivers the image data to the general-purpose printer driver 10a. Then, the general-purpose printer driver 10a displays a standard print dialog 15 of Windows illustrated in FIG. 3 on the LCD 2c. The print dialog 15 is also referred to as a Print Dialog, a Print Setup Dialog, a Common Print Dialog, or a System Print Dialog.

Typically, a print setting area 15a, a print execution button 15b, and a print cancel button 15c are displayed in the print dialog 15.

In the print setting area 15a, various items are arranged so that the user can input print settings. The various items typically include a device list box 16, a radio button and a text box for setting a range of pages to be printed, a text box for setting the number of copies to be printed, and the like.

In the present embodiment, the device list box 16 displays a printing device which is selected when image data is printed, a FAX transmission device which is selected when image data is transmitted by FAX, and other devices in a selectable manner. Among the plurality of devices displayed in the device list box 16, a "printer A" and a "printer A (FAX)" correspond to the multifunction peripheral 3. The "printer A" indicates a printing function of the multifunction peripheral 3. The "printer A (FAX)" indicates a PC-FAX function of the multifunction peripheral 3. Therefore, the user selects the "printer A" in the device list box 16 when printing the document data, and selects the "printer A (FAX)" in the device list box 16 when transmitting the document data by FAX.

When the print execution button 15b is pressed, the general-purpose printer driver 10a generates a job based on the image data received from the document creation application 11 and the print settings set in the print setting area 15a, and delivers the generated job to the print spooler 10b. When the "printer A" is selected, the general-purpose printer driver 10a generates a print job. On the other hand, when the "printer A (FAX)" is selected, the general-purpose printer driver 10a generates a fax transmission job. Each of the print job and the FAX transmission job is a specific example of a job.

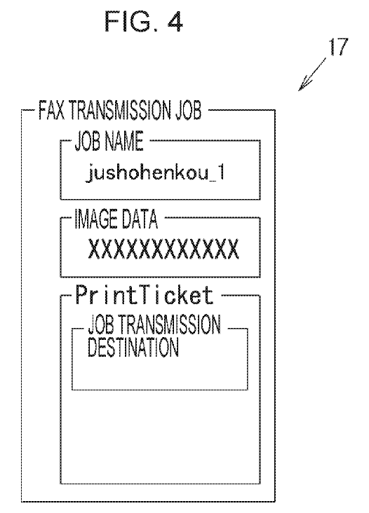

FIG. 4 illustrates a data structure of a FAX transmission job 17 generated by the general-purpose printer driver 10a. As illustrated in FIG. 4, the FAX transmission job 17 typically includes a job name, image data, and a PrintTicket. The job name is used for the user to identify the FAX transmission job 17. The image data is typically in TIFF format or PDF format. The general-purpose printer driver 10a converts the image data in XPS format or GDI format received from the document creation application 11 into image data in TIFF format or PDF format, and stores the converted image data in the FAX transmission job 17. The PrintTicket indicates job setting information for the FAX transmission job 17. The PrintTicket includes a job transmission destination and other job settings. The job transmission destination is set with a FAX number for identifying a FAX transmission destination that is one of the FAX machine 4a to the FAX machine 4d. The other job settings typically include the print settings set in the print setting area 15a. In the present embodiment, as illustrated in FIG. 4, at the stage when the general-purpose printer driver 10a generates the FAX transmission job 17, the job name is set and the job transmission destination is not set.

When the print cancel button 15c is pressed, the general-purpose printer driver 10a closes the print dialog 15 and ends the process.

Referring back to FIG. 2, the PSA 12 is a specific example of an extension application. The PSA 12 includes a FAX transmission job acquisition unit 20, a job transmission destination reception unit 21, a FAX transmission job generation unit 22, a job transmission destination setting unit 23, a job name setting unit 24, a job transmission unit 25, and a job storage unit 26.

The FAX transmission job acquisition unit 20 is a specific example of a FAX transmission job acquisition unit. The job transmission destination reception unit 21 is a specific example of a job transmission destination reception unit. The FAX transmission job generation unit 22 is a specific example of a FAX transmission job generation unit. The job transmission destination setting unit 23 is a specific example of a job transmission destination setting unit. The job name setting unit 24 is a specific example of a job name setting unit. The job transmission unit 25 is a specific example of a job transmission unit. The job storage unit 26 is a specific example of a job storage unit.

The FAX transmission job acquisition unit 20 acquires the FAX transmission job 17 (first FAX transmission job) in FIG. 4 generated by the general-purpose printer driver 10a. The general-purpose printer driver 10a does not directly deliver the generated FAX transmission job 17 to PSA 12, but delivers the FAX transmission job 17 to the print spooler 10b. Therefore, the FAX transmission job acquisition unit 20 acquires, from the print spooler 10b, the FAX transmission job 17 generated by the general-purpose printer driver 10a.

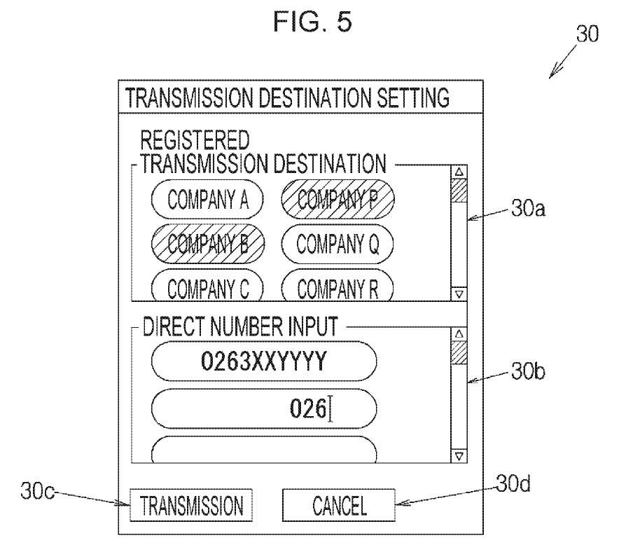

The job transmission destination reception unit 21 receives a plurality of job transmission destinations as job transmission destinations of the FAX transmission job 17. Specifically, the job transmission destination reception unit 21 displays a transmission destination setting dialog 30 illustrated in FIG. 5 on the LCD 2c. The transmission destination setting dialog 30 typically displays a registered transmission destination selection area 30a, a direct number input area 30b, a FAX transmission execution button 30c, and a FAX transmission cancel button 30d.

In the registered transmission destination selection area 30a, a plurality of job transmission destinations registered in the PSA 12 in advance are typically displayed side by side in the form of icons. The user can select one or a plurality of job transmission destinations by a click operation in the registered transmission destination selection area 30a.

In the direct number input area 30b, a plurality of text boxes are displayed side by side. The user can input one or more transmission destinations by keyboard input in the direct number input area 30b.

In this way, the job transmission destination reception unit 21 receives one or a plurality of job transmission destinations selected in the registered transmission destination selection area 30a or input in the direct number input area 30b, as job transmission destinations for the FAX transmission job 17.

When the FAX transmission execution button 30c is pressed, the reception process of the job transmission destination reception unit 21 is completed. When the FAX transmission cancel button 30d is pressed, the reception process of the job transmission destination reception unit 21 is canceled. In this case, typically, the print dialog 15 illustrated in FIG. 3 is displayed again on the LCD 2c.

The FAX transmission job generation unit 22 generates at least one FAX transmission job 18 (second FAX transmission job) including the image data of the FAX transmission job 17. Specifically, when the job transmission destination reception unit 21 receives a plurality of job transmission destinations, the FAX transmission job generation unit 22 generates at least one FAX transmission job 18. On the other hand, when the job transmission destination reception unit 21 receives only one job transmission destination, the FAX transmission job generation unit 22 does not generate the FAX transmission job 18.

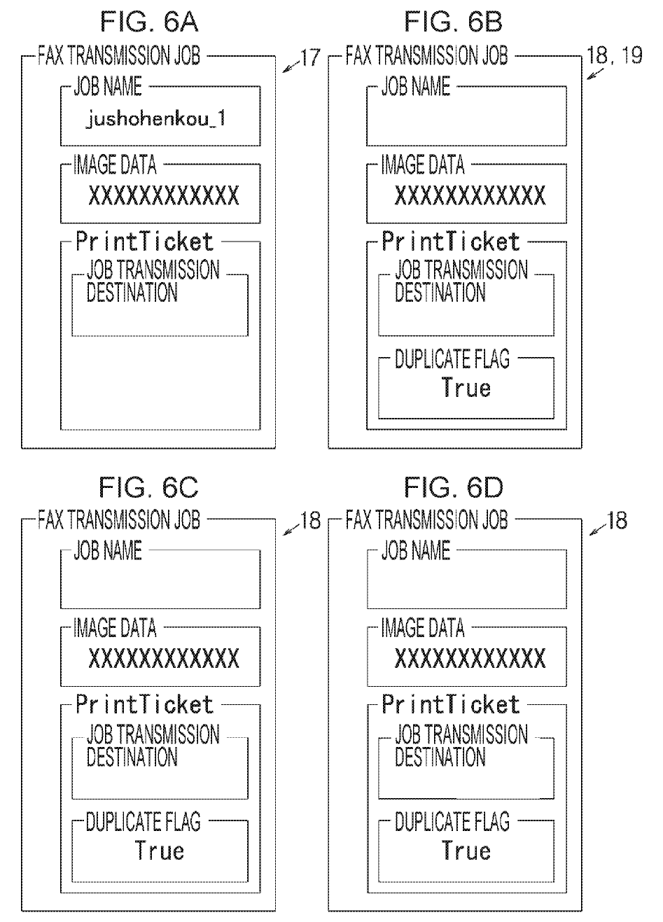

FIGS. 6A to 6D illustrate the FAX transmission job 17 acquired by the FAX transmission job acquisition unit 20 and the plurality of FAX transmission jobs 18 generated by the FAX transmission job generation unit 22. For convenience of description, it is assumed herein that the user selects or inputs four job transmission destinations in the transmission destination setting dialog 30 of FIG. 5. In this case, the FAX transmission job generation unit 22 newly generates three FAX transmission jobs 18 as illustrated in FIGS. 6B to 6D. Thus, the total number of jobs of the FAX transmission job 17 acquired by the FAX transmission job acquisition unit 20 and the plurality of FAX transmission jobs 18 generated by the FAX transmission job generation unit 22 matches the number of job transmission destinations selected or input by the user in the transmission destination setting dialog 30. In short, it can be said that the FAX transmission job generation unit 22 generates FAX transmission jobs as many as the plurality of job transmission destinations selected or input by the user in the transmission destination setting dialog 30.

The total number of jobs of the FAX transmission jobs 18 generated by the FAX transmission job generation unit 22 is generalized as follows. In other words, when the number of job transmission destinations selected or input by the user in the transmission destination setting dialog 30 is N, the FAX transmission job generation unit 22 generates (N-1) FAX transmission jobs 18. Naturally, when N is 1, the FAX transmission job generation unit 22 does not generate the FAX transmission job 18.

As illustrated in FIGS. 6B to 6D, each of the three FAX transmission jobs 18 generated by the FAX transmission job generation unit 22 includes the same image data as the image data included in the FAX transmission job 17. At this time, the job name of each of the FAX transmission jobs 18 is not set. In addition, as illustrated in FIGS. 6B to 6D, a duplicate flag (a flag value is typically True) is newly provided in the PrintTicket of the three FAX transmission jobs 18 generated by the FAX transmission job generation unit 22. The duplicate flag is provided to distinguish between the FAX transmission job 17 generated by the general-purpose printer driver 10a and the FAX transmission job 18 generated by the FAX transmission job generation unit 22.

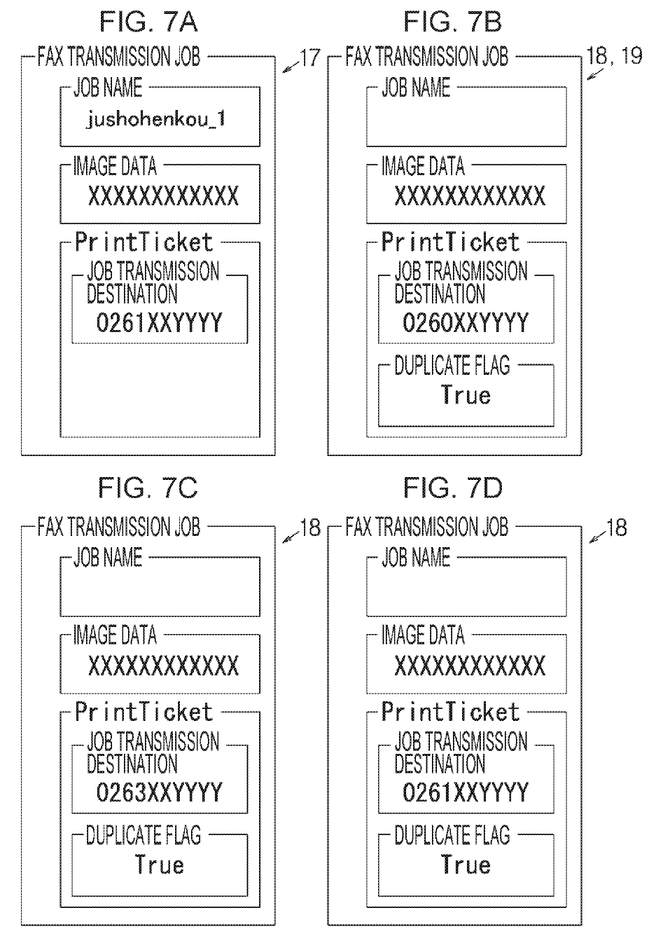

As illustrated in FIGS. 7A to 7D, the job transmission destination setting unit 23 sets the job transmission destinations of the FAX transmission job 17 and the plurality of FAX transmission jobs 18 as the plurality of job transmission destinations received by the job transmission destination reception unit 21.

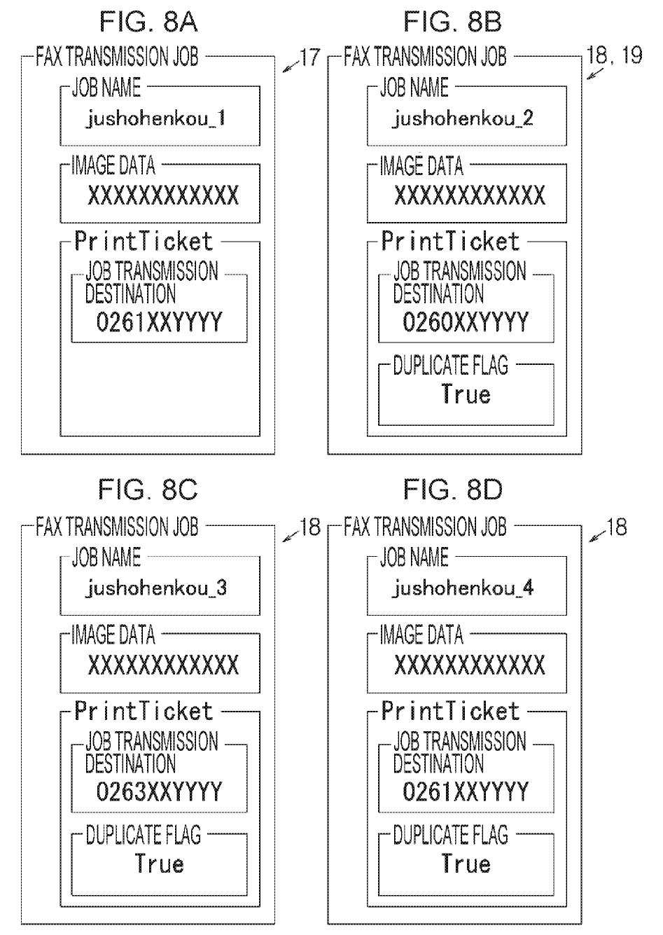

As illustrated in FIGS. 8A to 8D, the job name setting unit 24 sets job names of the plurality of FAX transmission jobs 18. For example, when the job name of the FAX transmission job 17 is "jushohenkou_1", the job name setting unit 24 may set the job names of the plurality of FAX transmission jobs 18 using serial numbers, such as "jushohenkou_2", "jushohenkou_3", and "jushohenkou_4".

The plurality of FAX transmission jobs 18 generated by the FAX transmission job generation unit 22 are delivered to the print spooler 10b at a stage where the setting process is completed by the job transmission destination setting unit 23 and the job name setting unit 24.

Hereinafter, for convenience of description, both the FAX transmission job 17 acquired by the FAX transmission job acquisition unit 20 and the plurality of FAX transmission jobs 18 generated by the FAX transmission job generation unit 22 are also referred to as FAX transmission jobs 19.

The job transmission unit 25 transmits the plurality of FAX transmission jobs 19. Specifically, every time the job transmission unit 25 receives the FAX transmission job 19 from the print spooler 10b, the job transmission unit 25 transmits the received FAX transmission job 19 to the multifunction peripheral 3. At this time, the job transmission unit 25 actually converts the received FAX transmission job 19 into an IPP request, and transmits the converted IPP request to the multifunction peripheral 3. The IPP request is a specific example of FAX data. The FAX transmission job 19 and the IPP request are different from each other only in data format, and are constituted by substantially the same information. The job transmission unit 25 determines, for each FAX transmission job 19, whether the multifunction peripheral 3 can accept the FAX transmission job 19, transmits the FAX transmission job 19 to the multifunction peripheral 3 when the FAX transmission job 19 can be accepted, and waits without transmitting the FAX transmission job 19 to the multifunction peripheral 3 when the FAX transmission job 19 cannot be accepted. Thus, the multifunction peripheral 3 does not receive the IPP request from the computer 2 during the process of the FAX transmission, whereby the FAX transmission of the multifunction peripheral 3 is stably implemented. Typically, the job transmission unit 25 can inquire of the print spooler 10b and determine whether the multifunction peripheral 3 can accept the FAX transmission job 19 based on a response from the print spooler 10b.

The job storage unit 26 stores the FAX transmission job 19 transmitted to the multifunction peripheral 3 by the job transmission unit 25 so that the FAX transmission job 19 can be retransmitted. In other words, after transmitting the FAX transmission job 19 to the multifunction peripheral 3, the job transmission unit 25 deletes the FAX transmission job 19. Furthermore, after executing the FAX transmission of the FAX transmission job 19, the multifunction peripheral 3 deletes the FAX transmission job 19. Accordingly, when the multifunction peripheral 3 fails in FAX transmission, the FAX transmission job 19 cannot be retransmitted. Therefore, the job storage unit 26 stores the FAX transmission job 19 that has already been transmitted, so that the job transmission unit 25 can retransmit the FAX transmission job 19. Further, since the job storage unit 26 stores the FAX transmission job 19 that has already been transmitted, it is possible to manage a transmission history of the FAX transmission performed by the multifunction peripheral 3.

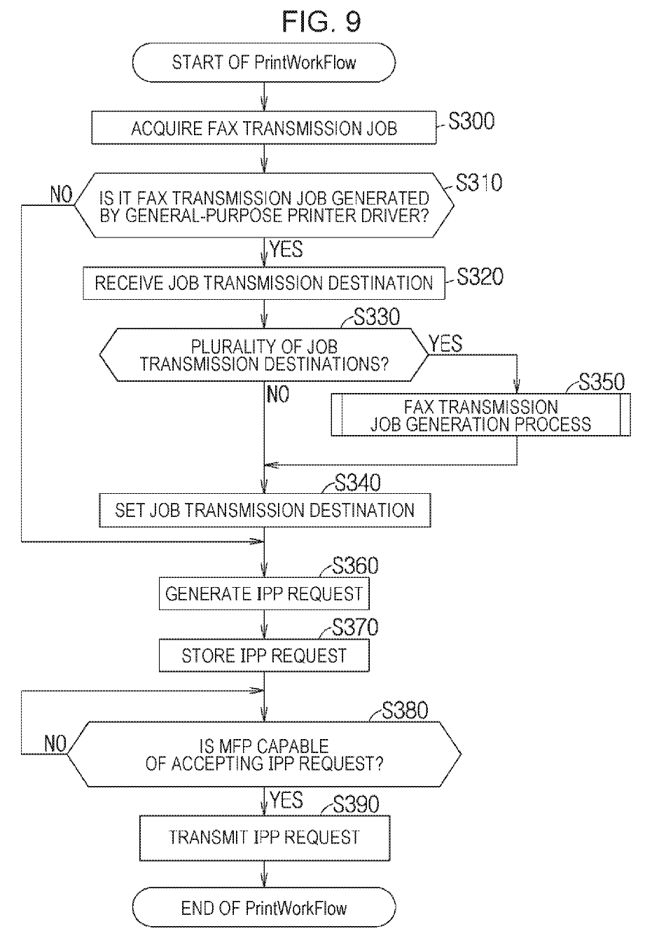

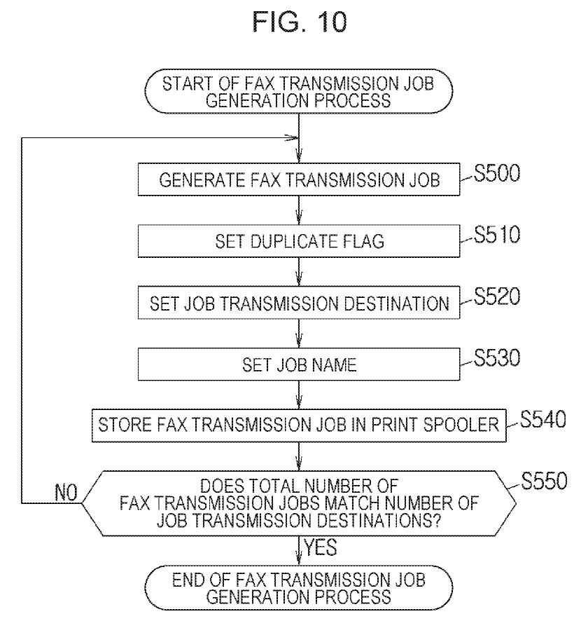

Next, a control flow of the computer 2 will be described with reference to FIGS. 9 to 11. FIGS. 9 and 10 illustrate a control flow of the PSA 12.

First, when the user creates document data using the document creation application 11 and instructs the document creation application 11 to print, the document creation application 11 calls the general-purpose printer driver 10a, converts the document data into image data in the XPS format or the GDI format, and delivers the image data to the general-purpose printer driver 10a. The general-purpose printer driver 10a generates the FAX transmission job 17 based on the image data received from the document creation application 11 and the print settings set in the print setting area 15a, and delivers the FAX transmission job 17 to the print spooler 10b.

The print spooler 10b checks an operation state of the multifunction peripheral 3, delivers the FAX transmission job 17 to PSA 12 at a timing at which the multifunction peripheral 3 is not executing the FAX transmission process, and starts a PrintWorkFlow of PSA 12 illustrated in FIGS. 9 and 10.

In other words, the FAX transmission job acquisition unit 20 of the PSA 12 acquires the FAX transmission job 19 generated by the general-purpose printer driver 10a from the print spooler 10b (S300).

Next, the job transmission destination reception unit 21 of the PSA 12 determines whether the FAX transmission job 19 acquired by the FAX transmission job acquisition unit 20 is the FAX transmission job 17 generated by the general-purpose printer driver 10a (S310). At this time, the job transmission destination reception unit 21 can execute the above-described determination based on whether a duplicate flag is set in the PrintTicket of the FAX transmission job 19 acquired by the FAX transmission job acquisition unit 20. When the job transmission destination reception unit 21 determines that the FAX transmission job 19 acquired by the FAX transmission job acquisition unit 20 is not the FAX transmission job 17 generated by the general-purpose printer driver 10a (NO in S310), the process proceeds to step S360. On the other hand, when the job transmission destination reception unit 21 determines that the FAX transmission job 19 acquired by the FAX transmission job acquisition unit 20 is the FAX transmission job 17 generated by the general-purpose printer driver 10a (YES in S310), the process proceeds to step S320.

In step S320, the job transmission destination reception unit 21 receives one or a plurality of job transmission destinations as the job transmission destination of the FAX transmission job 17 (S320).

Next, the FAX transmission job generation unit 22 determines whether the job transmission destination reception unit 21 receives a plurality of job transmission destinations (S330). When the job transmission destination reception unit 21 does not receive the plurality of job transmission destinations (NO in S330), the FAX transmission job generation unit 22 does not newly generate a FAX transmission job 18, and the process proceeds to step S340. On the other hand, when the job transmission destination reception unit 21 receives the plurality of job transmission destinations (YES in S330), the FAX transmission job generation unit 22 executes a FAX transmission job generation process (S350), and the process proceeds to step S340.

FIG. 10 illustrates the FAX transmission job generation process. As illustrated in FIG. 10, the FAX transmission job generation unit 22 first generates a FAX transmission job 18 (S500). The FAX transmission job 18 generated by the FAX transmission job generation unit 22 in step S500 contains only the same image data as the image data in the FAX transmission job 17.

Next, the FAX transmission job generation unit 22 sets a duplicate flag in the PrintTicket of the FAX transmission job 18 generated in step S500 (S510).

Next, the job transmission destination setting unit 23 sets the job transmission destination of the FAX transmission job 18 generated in step S500 as a second job transmission destination among the plurality of job transmission destinations received by the job transmission destination reception unit 21 (S520).

Next, the job name setting unit 24 sets a job name for the FAX transmission job 18 generated in step S500 (S530).

Next, the FAX transmission job generation unit 22 stores the FAX transmission job 18 generated in step S500 in the print spooler 10b (S540).

Then, the FAX transmission job generation unit 22 determines whether the total number of jobs of the FAX transmission job 17 and the FAX transmission jobs 18 generated by the FAX transmission job generation unit 22 matches the number of job transmission destinations received by the job transmission destination reception unit 21 (S550). When the FAX transmission job generation unit 22 determines not to match (NO in S550), the process returns to step S500. Thereafter, in step S520, the job transmission destination setting unit 23 sets the job transmission destination of the FAX transmission job 18 generated in step S500 as the next job transmission destination among the plurality of job transmission destinations received by the job transmission destination reception unit 21 (S520). On the other hand, when the FAX transmission job generation unit 22 determines to match (YES in S550), the FAX transmission job generation process ends, and the process proceeds to step S340 in FIG. 9.

Returning to FIG. 9, the job transmission destination setting unit 23 sets the job transmission destination of the FAX transmission job 17 acquired by the FAX transmission job acquisition unit 20 to a first job transmission destination among the plurality of job transmission destinations received by the job transmission destination reception unit 21 (S340).

Next, the job transmission unit 25 converts the FAX transmission job 19 being passed from the print spooler 10b and currently held by PSA 12 into an IPP request (S360). Next, the job storage unit 26 stores the converted IPP request (S370).

Next, the job transmission unit 25 determines whether the multifunction peripheral 3 can accept the FAX transmission job 19 (S380). When it is determined that the FAX transmission job is acceptable (YES in S380), the job transmission unit 25 transmits the IPP request to the multifunction peripheral 3 (S390), and the PrintWorkFlow ends. On the other hand, when it is determined that the FAX transmission job is not acceptable (NO in S380), the job transmission unit 25 does not transmit the IPP request to the multifunction peripheral 3, and waits until the FAX transmission job is acceptable.

In this way, the first FAX transmission job 19, that is, the FAX transmission job 17 is transmitted to the multifunction peripheral 3 by the PrintWorkFlow of the PSA 12. The print spooler 10b calls the PrintWorkFlow of the PSA 12 again, and delivers a first one of the FAX transmission jobs 18, that is, the second FAX transmission job 19 among the plurality of FAX transmission jobs 18 generated by the FAX transmission job generation unit 22 and stored in the print spooler 10b to the PSA 12.

In this case, the job transmission destination reception unit 21 determines in step S310 of FIG. 9 that the FAX transmission job 19 acquired by the FAX transmission job acquisition unit 20 is not the FAX transmission job 17 generated by the general-purpose printer driver 10a (NO in S310), the process proceeds to step S360.

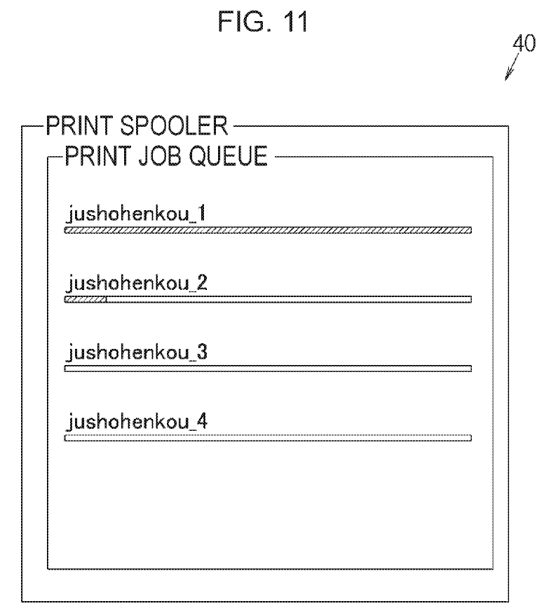

FIG. 11 illustrates a management window 40 for a FAX transmission job by the print spooler 10b. As illustrated in FIG. 11, the print spooler 10b stores a plurality of FAX transmission jobs 19, and typically displays a progress status of each of the plurality of FAX transmission jobs 19 using a progress bar. In the example of FIG. 11, the FAX transmission job 19 with the job name "jushohenkou_1" has been completed, and the FAX transmission job 19 with the job name "jushohenkou_2" is currently being processed.

The preferred embodiment of the present disclosure has been described above. The above embodiment has the following features.

That is, the program stored in the memory 2b causes the computer 2 to function as the PSA 12 (extension application) that extends the general-purpose printer driver 10a. The PSA 12 includes the FAX transmission job acquisition unit 20, the job transmission destination reception unit 21, the FAX transmission job generation unit 22, the job transmission destination setting unit 23, and the job transmission unit 25. The FAX transmission job acquisition unit 20 acquires the FAX transmission job 17 (first FAX transmission job) generated by the general-purpose printer driver 10a. The job transmission destination reception unit 21 receives a plurality of job transmission destinations as job transmission destinations of the FAX transmission job 17. The FAX transmission job generation unit 22 generates at least one FAX transmission job 18 (second FAX transmission job) including the image data of the FAX transmission job 17. The job transmission destination setting unit 23 sets respective job transmission destinations of the plurality of FAX transmission jobs 19 including the FAX transmission job 17 and at least one FAX transmission job 18 as the plurality of job transmission destinations received by the job transmission destination reception unit 21. The job transmission unit 25 transmits the plurality of FAX transmission jobs 19 to the multifunction peripheral 3 (external device). According to the above-described configuration, the PSA 12 is implemented which is capable of transmitting the same image data to the plurality of job transmission destinations by FAX.

The PSA 12 further includes the job name setting unit 24 that sets the job name of at least one FAX transmission job 18. According to the above-described configuration, the job name of at least one FAX transmission job 18 generated by the FAX transmission job generation unit 22 is set.

For each FAX transmission job 19, the job transmission unit 25 transmits the FAX transmission job 19 to the multifunction peripheral 3 when the multifunction peripheral 3 can accept the FAX transmission job 19, and waits without transmitting the FAX transmission job 19 to the multifunction peripheral 3 when the multifunction peripheral 3 cannot accept the FAX transmission job 19. According to the above configuration, stable FAX transmission of the multifunction peripheral 3 is implemented.

In addition, the PSA 12 further stores the plurality of FAX transmission jobs 19 transmitted by the job transmission unit 25 to enable retransmission. According to the above-described configuration, the plurality of FAX transmission jobs 19 transmitted by the job transmission unit 25 can be retransmitted.

Furthermore, at least one FAX transmission job 18 includes information indicating that the at least one FAX transmission job 18 is not the FAX transmission job 17. In the present embodiment, the information indicating that the job is not the FAX transmission job 17 is, for example, the duplicate flag set in the PrintTicket of each FAX transmission job 18 illustrated in FIGS. 8B to 8D. According to the above-described configuration, when the PSA 12 receives the FAX transmission job 19 from the print spooler 10b, the PSA 12 can easily determine whether the FAX transmission job generation unit 22 needs to generate the FAX transmission job 18. Specifically, when the PSA 12 receives the FAX transmission job 19 from the print spooler 10b, if the duplicate flag is set in the PrintTicket of the FAX transmission job 19, the PSA 12 can determine that the FAX transmission job generation unit 22 does not need to generate the FAX transmission job 18.

Although the disclosure made by the present inventor has been specifically described based on the embodiment, the present disclosure is not limited to the above-described embodiment, various modifications can be made without departing from the gist thereof.

For example, in FIG. 10, the PSA 12 generates a FAX transmission job 18 and then generates a PrintTicket corresponding to the FAX transmission job 18. Alternatively, however, the PSA 12 may generate a PrintTicket and then generate a FAX transmission job 18 corresponding to the PrintTicket.

In the above example, the program can be stored using various types of non-transitory computer-readable media and can be supplied to the computer. The non-transitory computer-readable media include various types of tangible storage media. Examples of the non-transitory computer-readable media include magnetic recording media (for example, a flexible disk, a magnetic tape, and a hard disk drive) and magneto-optical recording media (for example, a magneto-optical disk). Further examples of the non-transitory computer-readable media include a CD-read-only memory (ROM), a CD-R, a CD-R/W, and a semiconductor memory (for example, including a mask ROM). Additional examples of the non-transitory computer-readable media include a programmable ROM (PROM), an erasable PROM (EPROM), a flash ROM, and a random access memory (RAM). In addition, the program may be supplied to the computer by various types of transitory computer-readable media. Examples of the transitory computer-readable media include an electric signal, an optical signal, and an electromagnetic wave. The transitory computer-readable media can supply the program to the computer via a wired communication channel, such as an electric wire or an optical fiber, or a wireless communication channel.

What is claimed is:

1. A non-transitory computer-readable storage medium storing a FAX control program for causing a computer to function as an extension application that extends a general-purpose printer driver, wherein
the extension application includes
a FAX transmission job acquisition unit configured to acquire a first FAX transmission job generated by the general-purpose printer driver,
a job transmission destination reception unit configured to receive a plurality of job transmission destinations as job transmission destinations of the first FAX transmission job,
a FAX transmission job generation unit configured to generate at least one second FAX transmission job including image data of the first FAX transmission job,
a job transmission destination setting unit configured to set respective job transmission destinations of a plurality of FAX transmission jobs including the first FAX transmission job and the at least one second FAX transmission job to the plurality of job transmission destinations received by the job transmission destination reception unit, and
a job transmission unit configured to transmit the plurality of FAX transmission jobs to an external device.

2. The non-transitory computer-readable storage medium according to claim 1, wherein
the extension application is a Print Support Application.

3. The non-transitory computer-readable storage medium according to claim 1, wherein
the extension application further includes a job name setting unit configured to set a job name of the at least one second FAX transmission job.

4. The non-transitory computer-readable storage medium according to claim 1, wherein
the job transmission unit transmits, for each FAX transmission job, the FAX transmission job to the external device when the external device is capable of accepting the FAX transmission job, and waits without transmitting the FAX transmission job to the external device when the external device is not capable of accepting the FAX transmission job.

5. The non-transitory computer-readable storage medium according to claim 1, wherein
the extension application further includes a job storage unit configured to store the plurality of FAX transmission jobs transmitted by the job transmission unit in order to enable retransmission.

6. The non-transitory computer-readable storage medium according to claim 1, wherein
the at least one second FAX transmission job includes information indicating that the at least one second FAX transmission job is not the first FAX transmission job.

7. A FAX control device comprising:
a general-purpose printer driver; and
an extension application that extends the general-purpose printer driver, wherein
the extension application includes
a FAX transmission job acquisition unit configured to acquire a first FAX transmission job generated by the general-purpose printer driver,
a job transmission destination reception unit configured to receive a plurality of job transmission destinations as job transmission destinations of the first FAX transmission job,
a FAX transmission job generation unit configured to generate at least one second FAX transmission job including image data of the first FAX transmission job,
a job transmission destination setting unit configured to set respective job transmission destinations of a plurality of FAX transmission jobs including the first FAX transmission job and the at least one second FAX transmission job to the plurality of job transmission destinations received by the job transmission destination reception unit, and
a job transmission unit configured to transmit the plurality of FAX transmission jobs to an external device.

8. A control method for a FAX control device including a general-purpose printer driver and an extension application that extends the general-purpose printer driver,
the control method comprising:
acquiring, by the extension application, a first FAX transmission job generated by the general-purpose printer driver;
receiving, by the extension application, a plurality of job transmission destinations as job transmission destinations of the first FAX transmission job;
generating, by the extension application, at least one second FAX transmission job including image data of the first FAX transmission job;
setting, by the extension application, respective job transmission destinations of a plurality of FAX transmission jobs including the first FAX transmission job and the at least one second FAX transmission job to the plurality of job transmission destinations received; and
transmitting, by the extension application, the plurality of FAX transmission jobs to an external device.
